(19) United States
(12) Patent Application Publication
(10) Pub. No.: US 2017/0090922 A1
(43) Pub. Date: Mar. 30, 2017

(54) Efficient Instruction Pair for Central Processing Unit (CPU) Instruction Design

(71) Applicant: Futurewei Technologies, Inc., Plano, TX (US)

(72) Inventors: Jiajin Tu, Shanghai (CN); Michael Chow, Saratoga, CA (US); Yongxiang Liang, Beijing (CN); Yongzheng Hao, Beijing (CN); Xiaoyu Wang, Beijing (CN); Jiamin Zheng, Beijing (CN); Shilei Liao, Beijing (CN)

(21) Appl. No.: 14/871,229

(22) Filed: Sep. 30, 2015

(51) Int. Cl. G06F 9/30

(52) U.S. Cl. CPC G06F 9/3016; G06F 9/30101

(57) ABSTRACT

A method implemented by a central processing unit (CPU), comprising decoding a first instruction word of a first instruction pair, wherein the first instruction word comprises a first operation code identifying a first operation, storing the first operation code in a register memory upon decoding the first instruction word, decoding a second instruction word of the first instruction pair, wherein the second instruction word comprises a first operand, generating a first decoded instruction pair by combining the first operation code stored in the register memory with the first operand in the second instruction word. The method further comprises executing the first decoded instruction pair by performing the first operation on the first operand.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A central processing unit (CPU) is the hardware within an electronic computing device, such as a computer, that carries out instructions of a computer program. The instructions are typically encoded in a binary format. The binary representations of the instructions are referred to as instruction words. The instruction words of a computer program may be stored in memory, which may be CPU internal memory or external memory. To execute the computer program, the CPU fetches instruction words from the memory, decodes the fetched instruction words into decoded instructions, and executes the decoded instructions until the computer program instructs the CPU to stop. An instruction word may include an operation code or a control code and one or more operands. An operation code or the control code may identify an arithmetic operation, such as add, subtract, multiply, or a logical operation, such as a bit-wise “Or” operation, a bit-wise “And” operation. An operand may comprise a numeric value, an address of a memory location, or a register identifier (ID) that identifies a register. The instruction words may be encoded or represented by employing various mechanisms depending on the CPU architecture and the instruction set architecture.

### SUMMARY

In one embodiment, the disclosure includes a method implemented by a CPU, comprising decoding a first instruction word of a first instruction pair, wherein the first instruction word comprises a first operation code identifying a first operation, storing the first operation code in a register memory upon decoding the first instruction word, decoding a second instruction word of the first instruction pair, wherein the second instruction word comprises a first operand, generating a first decoded instruction pair by combining the first operation code stored in the register memory with the second instruction word, and executing the first decoded instruction pair by performing the first operation on the first operand.

In another embodiment, the disclosure includes a CPU comprising a register memory, a control unit coupled to the register memory and configured to decode a first instruction word of a first instruction pair, wherein the first instruction word comprises a first operation code identifying a first operation, store the first operation code in the register memory, decode a second instruction word of the first instruction pair, wherein the second instruction word comprises a first operand, and generate a first decoded instruction pair by combining the first operation code stored in the register memory with the first operand in the second instruction word and an execution unit coupled to the control unit and configured to execute the first decoded instruction pair by performing the first operation on the first operand.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a pipelined CPU;

FIG. 2 is a timing diagram illustrating an embodiment of a schedule for pipeline processing;

FIG. 3 is a functional diagram of an embodiment of a pipelined CPU that implements instruction pairs;

FIG. 4 is a timing diagram illustrating an embodiment of a schedule for processing instruction pairs in a pipelined CPU;

FIG. 5 is a schematic diagram of an embodiment of an encoding format for an instruction pair;

FIG. 6 is a schematic diagram of an embodiment of a program code segment;

FIG. 7 is a schematic diagram of an embodiment of a save operation code (save_op) register group; and

FIG. 8 is a flowchart of a method for processing an instruction pair.

### DETAILED DESCRIPTION

It should be understood at the outset that, although illustrative implementations of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

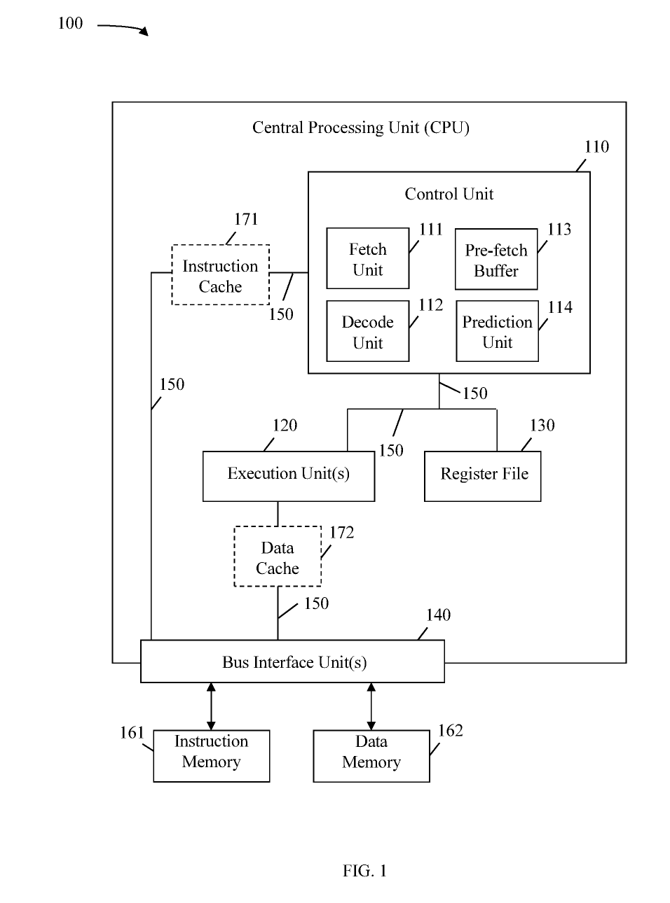

FIG. 1 is a schematic diagram of an embodiment of a pipelined CPU 100. The CPU 100 comprises a control unit 110, one or more execution units 120, a register file 130, and one or more bus interface units 140 interconnected by a plurality of signal connections 150. The signal connections 150 comprise signal lines that carry control signals and data signals between the control unit 110, the execution units 120, the register file 130, and the bus interface units 140. The bus interface unit 140 comprises logic circuits configured to interface the CPU 100 with an instruction memory 161 and a data memory 162. The instruction memory 161 and the data memory 162 may be any memory storage devices, such as random-access memory (RAM) and read-only memory (ROM). In one embodiment, the CPU 100 may employ a single bus interface unit 140 to interface with both the instruction memory 161 and the data memory 162. In another embodiment, the CPU 100 may employ one bus interface unit 140 to interface with the instruction memory 161 and another bus interface unit 140 to interface with the data memory 162. The bus interface units 140 may be further configured to interface the CPU 100 with other external components, such as peripherals and other processing units.

The main operations of the CPU 100 are to fetch program instructions from the instruction memory 161, determine the actions required by the program instructions, and carry out the actions. The execution of the program instructions may require reading data from the data memory 162 and writing data to the data memory 162. As shown, the CPU 100 may optionally include an instruction cache 171 coupled between the control unit 110 and the bus interface units 140 and/or a data cache 172 coupled between the execution units 120 and the bus interface units 140. The instruction cache 171 is an internal CPU memory configured to store copies of some of the program instructions stored in the instruction memory 161 to reduce instruction access time. The data cache 172 is an internal CPU memory configured to store copies of some of the data stored in the data memory 162 to reduce data access time.

The register file 130 is an internal CPU memory with a fast access time. The register file 130 may comprise about 10-32 words or registers for quick storages and retrievals of data from the data memory 162 and instructions from the instruction memory 161. Some examples of registers may include a program counter (PC), a stack pointer (SP), system registers, and/or general-purpose registers. For example, a PC may store an address of a program instruction in the instruction memory 161 for execution, an SP may store an address of a scratch area in the data memory 162 for temporary storage, system registers may store controls for CPU behaviors, such as enabling and disabling interrupts, and general-purpose registers may store general data and/or addresses for carrying out instructions of a computer program. In some embodiments, general-purpose registers are accessible by any user programs such as applications, whereas system registers are accessible by certain privileged programs, such as an operating system. It should be noted that the internal memory employed for the register file 130, the internal memory employed for the instruction cache 171, and the internal memory employed for the data cache 172 may be the same internal memory or different internal memory.

The execution units 120 may comprise an arithmetic logic unit (ALU), a load/store unit (LSU), a multiplier, a divider, a floating-point processing unit, and other processing units. The ALU comprises logic circuits configured to perform arithmetic and bitwise logical operations on integer binary numbers. The LSU comprises logic circuits configured to manage load and store operations between registers in the register file 130 and the data memory 162. The multiplier comprises logic circuits configured to perform integer multiplications. The divider comprises logic circuits configured to perform integer divisions. The floating-point processing unit comprises logic circuits configured to perform floating-point operations.

The control unit 110 controls and schedules the execution of program instructions. For example, the program instructions are encoded in machine codes specific to the CPU 100 and sequentially stored in the instruction memory 161. The encoded program instructions are referred to as instruction words. In various embodiments, the control unit 110 comprises a fetch unit 111 and a decode unit 112. The fetch unit 111 comprises logic circuits configured to fetch the instruction words from the instruction memory 161 via the bus interface unit 140 or from the instruction cache 171. The decode unit 112 is coupled to the fetch unit 111 and comprises logic circuits configured to decode the instruction words fetched by the fetch unit 111. An instruction word may comprise an operation code and one or more operands. The operation code indicates an action, which may be an add operation, a subtract operation, a multiply operation, or other arithmetic or logical operations. The operands indicate the data to be operated on by the operation code. An operand may be a source operand or a destination operand. An operand may be represented in several formats. For example, an operand may be a numerical data value, a register identifier (ID) that identifies a register in the register file 130, or a memory address identifying a location in the data memory 162. For example, the register ID is mapped to a CPU memory address of the register. An instruction word may further comprise other information, such as instruction class.

To support pipeline processing, the control unit 110 may further comprise a pre-fetch buffer 113 and a prediction unit 114. The pre-fetch buffer 113 stores instruction words fetched by the fetch unit 111 so that the fetch unit 111 may continuously fetch instruction words from the instruction memory 161 and the decode unit 112 may continuously decode the fetched instruction words stored in the pre-fetch buffer 113 without stalling. Stalling refers to waiting for execution resources, such as instructions, data, and bus accesses. The prediction unit 114 comprises logic circuits configured to predict an execution path upon fetching a conditional branching instruction so that the fetch unit 111 may continue to fetch a next instruction word prior to executing the conditional branching instruction. It should be noted that CPU 100 may be configured as shown or alternatively configured as determined by a person of ordinary skill in the art to achieve similar functionalities.

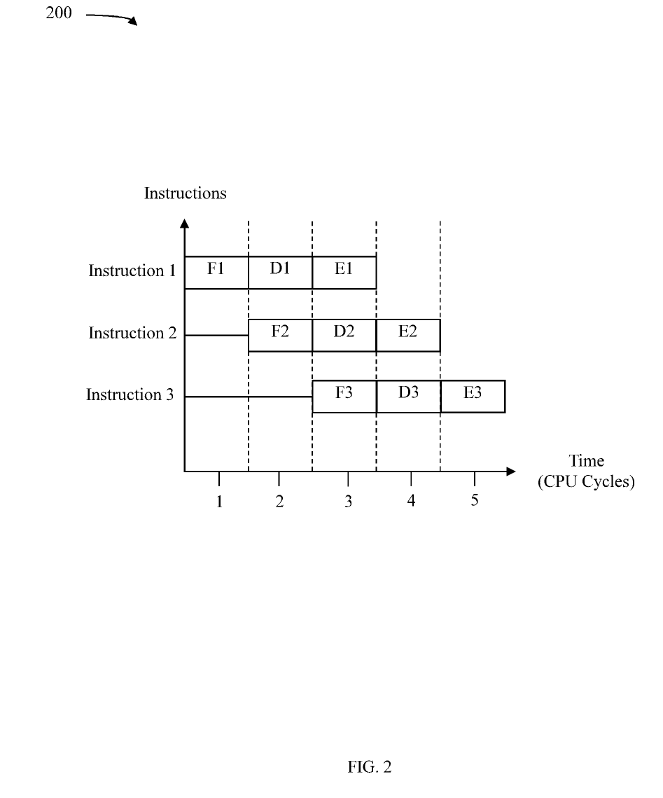

FIG. 2 is a timing diagram illustrating an embodiment of a schedule 200 for pipeline processing. The schedule 200 is employed by a pipelined CPU, such as the CPU 100, to allow overlapping executions of multiple instruction words. In FIG. 2, the x-axis represents time in units of CPU cycles and the y-axis represents instructions. For example, the CPU employs three pipeline stages, a fetch stage, a decode stage, and an execution stage, where an instruction fetch, decode, and execution, each takes one CPU cycle to complete. The CPU may employ a fetch unit, such as the fetch unit 111, to perform the instruction fetch, a decode unit, such as the decode unit 112, to perform the instruction decode, and an execution unit such as the execution unit 120 to perform instruction execution. The schedule 200 illustrates the fetching, decoding, and execution of three consecutive instructions, shown as instruction 1, 2, and 3. As shown, instruction 1 is fetched in CPU cycle 1, shown as F1, decoded in CPU cycle 2, shown as D1, and executed in CPU cycle 3, shown as E1. Instruction 2 is fetched in CPU cycle 2, shown as F2, decoded in CPU cycle 3, shown as D2, and executed in CPU cycle 4, shown as E2. Instruction 3 is fetched in CPU cycle 3, shown as F3, decoded in CPU cycle 4, shown as D3, and executed in CPU cycle 5, shown as E3. As shown, the CPU concurrently fetches instruction 3, decodes instruction 2, and executes instruction 1 in a single CPU cycle 3. The overlapping or concurrent fetch, decode, and execution continue as the CPU proceeds to process successive instructions. Thus, by dividing the processing of an instruction into multiple steps such as fetch, decode, and execute, and performing overlapping operations, the instruction throughput is increased. It should be noted that in some embodiments, each pipeline stage may be further divided into multiple sub-stages.

Many CPUs, such as the CPU 100 and reduced instruction set computing (RISC), employ a simplified instruction set such as a fixed-length binary-encoded instruction set to provide high performance. A common choice for the instruction word length is 32 bits. However, 32 bits may not be sufficient to represent complex operations that operate on many operands, for example, about five operands. For example, a CPU comprising a register file, such as the register file 130, comprising thirty-two registers may represent each register by a 5-bit register ID. To encode an instruction for a complex operation that operates on five source and/or destination registers, about 25 bits out of the 32 bits in an instruction word may be employed to represent the five source and/or destination registers. The remaining 7 bits may not be sufficient to represent the complex operation. There are various approaches to encoding complex operations that requires more operands. For example, a first approach limits the number of bits for representing a complex operation by employing a destructive register method, which reuses a source register as a destination register. However, the content of the source register is overwritten upon the execution of the complex operation. A second approach is to restrict complex operations to operate on a sub-set of CPU registers. For example, by restricting complex operations to operate on a sub-set of 16 registers instead of the full set of 32 registers. Thus, each operand may be represented by a 4-bit register ID instead of a 5-bit register ID. However, this approach may be limiting and may not efficiently utilize CPU resources. In order to preserve the contents of source registers and the flexibility of using the full set of CPU registers, a third approach combines two instruction words into an instruction pair to represent a single complex operation. For example, two 32-bit instruction words may be combined to form a 64-bit instruction pair for representing a single complex operation. An instruction pair is also referred to as a dual instruction. For example, a CPU may employ an instruction pair by copying the content of a source register to another register in a first instruction and re-using the source register as a source or a destination register in a second instruction. The following shows an example of such an instruction pair for a multiplication:

| | | |
|---|---|---|
| First instruction: | MOVPRFX | Zd, Zs1 |
| Second instruction: | MUL | Zd, Zs2, |

where the first instruction MOVPRFX copies the content of a register Zs1 to a different register Zd, and the second instruction multiples the content of Zs1 by the content of Zs2 and writes the product into the register Zd.

Although the above example CPU may extend the CPU's instruction space, the CPU fetches a pair of instruction words for each complex operation instead of fetching one instruction word per single instruction word operation. Thus, the example CPU performs at about 50 percent (%) instruction fetch efficiency for instruction pairs when compared to single word instructions. The decreased instruction fetch efficiency reduces CPU performance, and thus may not be desirable.

Disclosed herein are embodiments for extending the instruction space of a CPU by employing efficient instruction pairs encoding and processing mechanisms to achieve similar efficiency as single instruction word operation. The disclosed embodiments employ an instruction pair composed of a first instruction word encoded with an operation code, followed by a second instruction word encoded with operands. The operation code identifies an operation, such as add, subtract multiply, multiply-add, multiply-subtract, complex-multiply, and other complex algorithmic-specific operation. In an embodiment, the CPU saves the operation code into a system register, named save_op register, in a pipeline decode stage of the first instruction word while fetching the second instruction word. A system register is a special register for CPU system control usage. As such, at a decode stage of the second instruction word, the CPU may combine the operation code saved in the save_op register with the second instruction word to fully decode the instruction pair.

By encoding the operation code and the operands into separate instruction words and saving the operation code into the save_op register, the operation code may be combined with multiple second instruction words. For example, a subsequent instruction pair with the same operation code may be specified by providing the operands in a single second instruction word, eliminating the need to repeat the first instruction word. Thus, in contrast to the above example CPU architecture, the disclosed embodiments maintains the same instruction fetch efficiency for instruction pairs as for single word instruction instead of decreasing the instruction fetch efficiency by about 50%.

The disclosed embodiments support context switch by extending a register move instruction to copy the operation code from the save_op register to a general-purpose register and from the general-purpose register to the save_op register. A general-purpose register is a register for general usage. The disclosed embodiments handle cancellation of speculative execution and CPU exceptions by employing a circular queue for the save_op register. Thus, the save_op register is physically a group of registers, which is referred to as a save_op register group. For example, the instruction pair operation codes are stored in the save_op register group in an instruction-fetch order. In addition, the CPU employs a latest pointer to track a most recently uncommitted instruction pair operation code and a commit pointer to track a currently committed instruction pair operation code. Although the present disclosure describes the instruction pair in a context of 32-bit instruction words, the disclosed embodiments may be applied to any instruction word lengths and any CPU architectures. It should be noted that the terms “instruction” and “instruction word” are used interchangeably in the present disclosure.

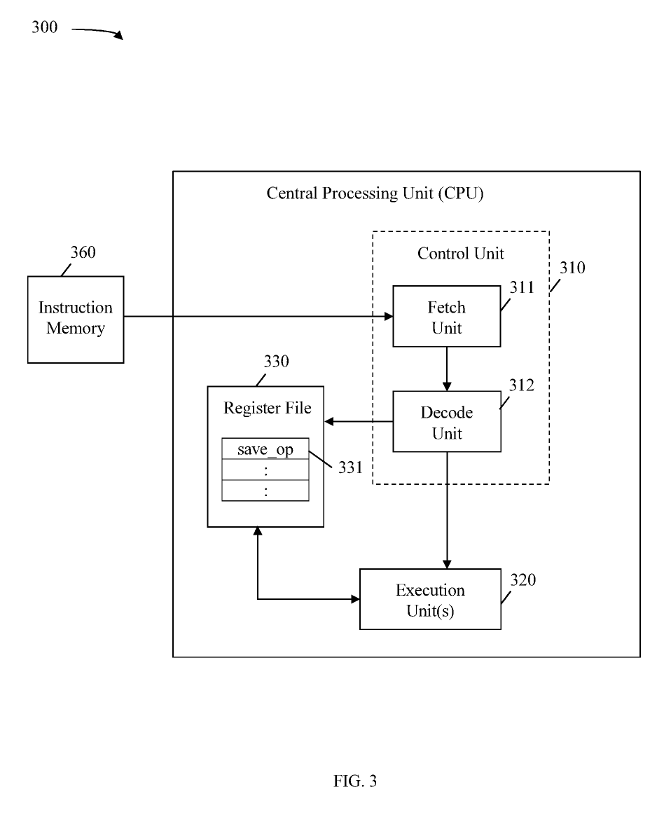

FIG. 3 is a functional diagram of an embodiment of a pipelined CPU 300 that implements instruction pairs. The CPU 300 comprises a similar architecture as the CPU 100. However, the CPU 300 provides an extended instruction space by combining a first instruction word encoded with an operation code with a second instruction encoded with operands to form an instruction pair. The CPU 300 comprises a control unit 310, one or more execution units 320, and a register file 330. The execution units 320 are similar to the execution units 120. The register file 330 is similar to the register file 130, comprises a save_op register 331 for supporting execution of instruction pairs in addition to system registers and general-purpose registers as in the register file 130. The control unit 310 comprises a fetch unit 311 and a decode unit 312. The control unit 310 may also comprise other control logics to coordinate CPU operations among the fetch unit 311, the decode unit 312, and the execution unit 320. The fetch unit 311 is similar to the fetch unit 111. For example, the fetch unit 311 fetches instruction words from an instruction memory 360 similar to the instruction memory 161. The fetch unit 311 may store the fetched instructions in a pre-fetch buffer (not shown) similar to the pre-fetch buffer 113. The decode unit 312 is similar to the decode unit 112, but is configured to decode instruction pairs in additions to single word instructions. As described above, an instruction pair comprises a first instruction word encoded with an operation code, followed by a second instruction word encoded with operands. The decode unit 312 saves the operation code into the save_op register 331 upon decoding the first instruction word in a decode stage of the first instruction word. For example, the decode stage of the first instruction word is concurrent with a fetch stage of the second instruction word. Thus, upon a decode stage of the second instruction word, the decode unit 312 may decode the second instruction by combining the operation code in the save_op register 331 with the second instruction word to generate a decoded instruction pair. In some embodiments, the control unit 310 may comprise other control logics configured to save the operation code into the save_op register 331 in the decode stage of the first instruction word and combine the operation code with the second instruction word in the decode stage of the second instruction word. Subsequently, the decoded instruction pair is passed to the execution unit 320 for execution. The pipeline operations for instruction pairs are discussed more fully below. Since the operation code is saved in the save_op register 331, a subsequent instruction pair with the sample operation code may be specified with a single second instruction word for indicting operands. Thus, the instruction fetch efficiency may be about the same for instruction pairs and single instruction operation. It should be noted that the save_op register 331 may comprise one or more physical storage elements or register memory, as discussed more fully below. In addition, the CPU 300 may be configured as shown or alternatively configured as determined by a person of ordinary skill in the art to achieve similar functionalities. In addition, the CPU 300 is suitable for employment as a general-purpose CPU, a digital signal processor (DSP), a vector processing unit (VPU), and may be integrated with other sub-systems in a system-on-chip (SoC).

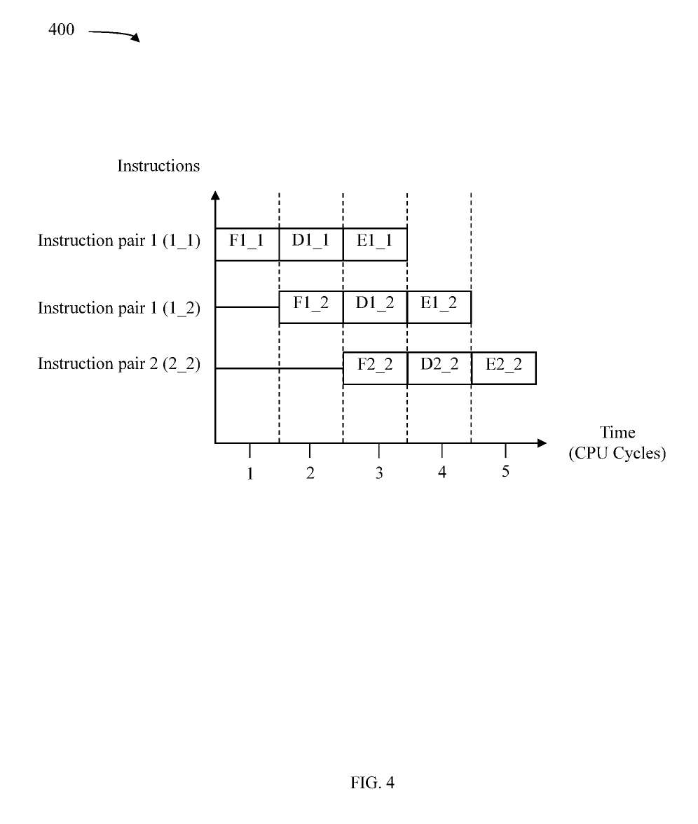

FIG. 4 is a timing diagram illustrating an embodiment of a schedule 400 for processing instruction pairs in a pipelined CPU, such as the CPU 300. In FIG. 4, the x-axis represents time in units of CPU cycles and the y-axis represents instructions. For example, the CPU employs three pipeline stages, a fetch stage, a decode stage, and an execution stage, where an instruction fetch, decode, and execution, each takes one CPU cycle to complete. The CPU may employ a fetch unit, such as the fetch unit 311 to perform the instruction fetch, a decode unit, such as the decode unit 312, to perform the instruction decode, and an execution unit, such as the execution unit 320, to perform instruction execution. The schedule 400 illustrates the fetching, decoding, and execution of two instruction pairs, denoted as instruction pair 1 and instruction pair 2, comprising the same operation code.

As shown, the CPU fetches a first instruction of the instruction pair 1, denoted as 1_1, in CPU cycle 1, shown as F_1_1. The CPU decodes the instruction 1_1 and copies the operation code embedded in the instruction 1_1 into a system register, such as the save_op register 331, in CPU cycle 2, shown as D1_1. The CPU executes the instruction 1_1 in CPU cycle 3, shown as E1_1. The CPU fetches a second instruction of the instruction pair 1, denoted as 1_2, in CPU cycle 2, shown as F_1_2. The CPU decodes the instruction 1_2 and combines the operation code saved in the system register with the instruction 1_2 to completely decode the instruction pair 1 in CPU cycle 3, shown as D1_2. The CPU executes the instruction pair 1 in CPU cycle 4, shown as E1_2. The CPU fetches a second instruction of the instruction pair 2, denoted as 2_2, in CPU cycle 3, shown as F2_2. The CPU decodes the instruction 2_2 and combines the operation code saved in the save_op register with the instruction 2_2 to completely decode the operation of the instruction pair 2 in CPU cycle 4, shown as D2_2. The CPU executes the instruction pair 2 in CPU cycle 5, shown as E2_2. As shown, the schedule 400 executes one instruction pair per CPU cycle, for example, at CPU cycles 4 and 5, with a single CPU cycle overhead at CPU cycle 3. Thus, when employing the schedule 400 to process multiple instruction pairs with the same operation code, the schedule 400 may maintain the instruction fetch and execution efficiency as a single instruction operation. It should be noted that in some embodiments, each pipeline stage may be further divided into multiple sub-stages and may require additional operational phases, such as data read and/or data write.

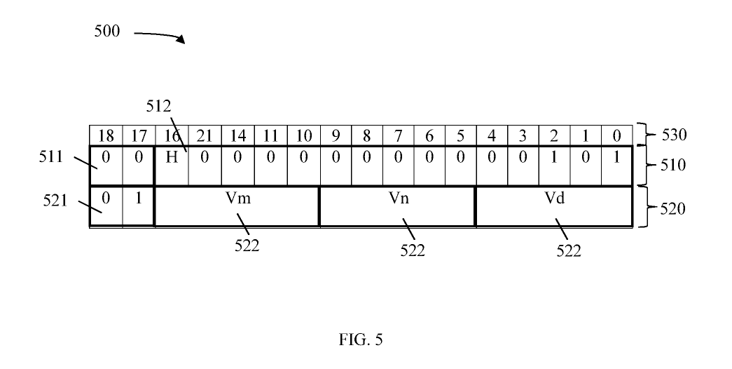

FIG. 5 is a schematic diagram of an embodiment of an encoding format for an instruction pair 500. The instruction pair 500 may be implemented in a CPU, such as the CPU 300. The instruction pair 500 comprises a first instruction word 510 and a second instruction word 520. The first instruction word 510 and the second instruction word 520 are binary encoded, where corresponding bit positions are shown as 530. The first instruction word 510 comprises a first instruction pair indicator 511 located at bit positions 17 and 18. As shown, the first instruction pair indicator 511 is set to a binary value of 00 to indicate that the first instruction word 510 is a first instruction word of the instruction pair 500 encoded with an operation code 512. The operation code 512 is a binary encoded representation of an operation, for example, complex-multiply. The second instruction word 520 comprises a second instruction pair indicator 521 similar to the first instruction pair indicator 511. However, the second instruction pair indicator 521 is set to a binary value of 01 to indicate that the second instruction word 520 is a second instruction word of the instruction pair 500 encoded with a plurality of operands 522, shown as Vm, Vn, and Vd, which are register IDs. The operands 522 comprise source operands and destination operands that are operated on by the operation represented by the operation code 512. As described above, the operation code 512 encoded in the first instruction word 510 is saved into a system register, such as the save_op register 331, in a decode stage of the first instruction word 510. As such, when the CPU decodes the second instruction word 520, the CPU may retrieve the operation code 512 from the system register to combine with the second instruction word 520. It should be noted the illustrated bits for the first instruction word 510 and the second instruction word 520 are variable bits specific to instruction pairs. The first instruction word 510 and the second instruction word 520 may further comprise additional bits, for example, to represent an instruction class. In addition, the instruction pair 500 may be encoded as shown or alternatively encoded as determined by a person of ordinary skill in the art to achieve similar functionalities.

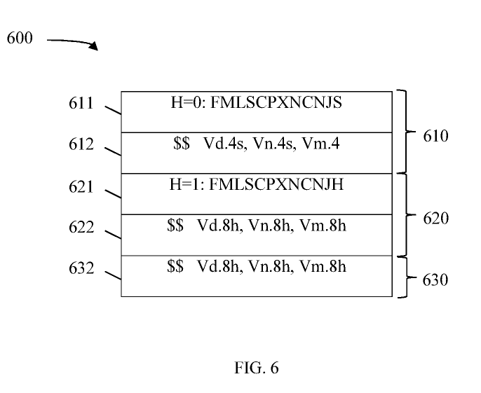

FIG. 6 is a schematic diagram of an embodiment of a program code segment 600. The program code segment 600 may be stored in an instruction memory, such as the instruction memory 161 and 360, and executed by a CPU, such as the CPU 300. The program code segment 600 comprises a first instruction pair 610, a second instruction pair 620, and a third instruction pair 630, which are instances of the instruction pair 500. The first instruction pair 610 comprises a first instruction word 611 corresponding to the first instruction word 510 and a second instruction word 612 corresponding to the second instruction word 520. As shown, the first instruction word 611 sets the H-bit (e.g., at bit position 16) of the operation code 512 to a value of 0 to represent a first operational type, for example, a 32-bit complex-multiply, where the instruction name is shown as FMLSCPXNCNJS. The second instruction word 612 indicates source and destination registers, shown as V1.4s, V2.4s, and V3.4s, which are 32-bit elements.

The second instruction pair 620 comprises a first instruction word 621 corresponding to the first instruction word 510 and a second instruction word 622 corresponding to the second instruction word 520. As shown, the first instruction word 621 sets the H-bit of the operation code 512 to a value of 1 to represent a second operational type, for example, a 16-bit complex-multiply, where the instruction name is shown as FMLSCPXNCNJH. The second instruction word 622 indicates source and destination registers, shown as V1.8h, V2.8h, and V3.8h, which are 16-bit elements.

The third instruction pair 630 comprises a single second instruction word 632 without a first instruction word indicating that the third instruction pair 630 comprises the same operation code as the previous second instruction pair 620. Thus, the third instruction pair 630 is also a 16-bit complex-multiply operation, but operates on a different set of register IDs, shown as V4.8h, V5.8h, and V6.8h.

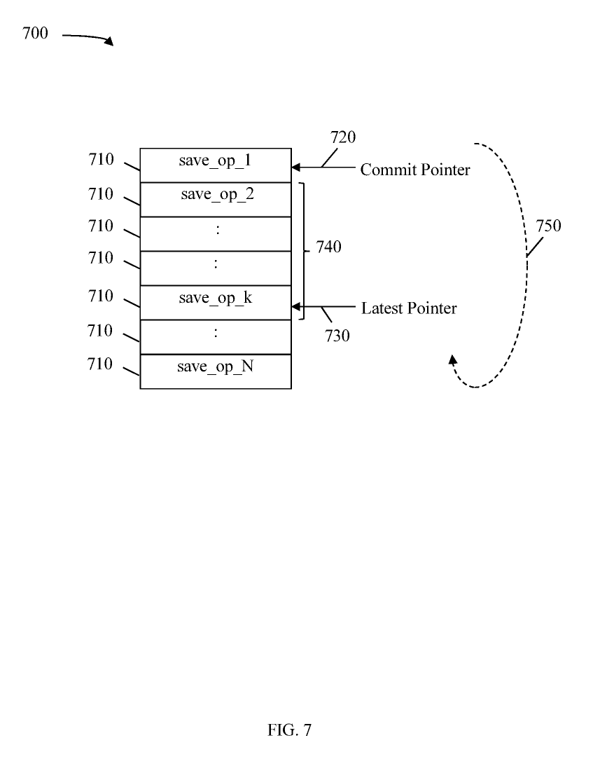

FIG. 7 is a schematic diagram of an embodiment of a save_op register group 700. The save_op register group 700 is similar to the save_op register 331, but provides a more detailed view of the physical structure. The save_op register group 700 is employed by a CPU such as the CPU 300. Specifically, the save_op register group 700 is located in a register file, such as the register file 330, of the CPU. The save_op register group 700 comprises a plurality of registers 710, shown as save_op_1 to N. The save_op register group 700 functions as a circular buffer queue. The registers 710 are configured to store instruction pair operation codes, such as the operation code 512. The instruction pair operation codes are stored sequentially in the save_op register group 700 in an instruction-fetch order. The CPU employs a commit pointer 720 to track a currently committed operation code in the save_op register group 700 and a latest pointer 730 to track a most recently uncommitted operation code. A committed operation code is an operation code that is committed for instruction pair execution, for example, when a first instruction word, such as the first instruction words 510, 611, and 621, encoded with the operation code is executed by an execution unit, such as the execution unit 320. A most recently uncommitted operation code is an operation code that is most recently saved into the save_op register group 700 when a first instruction word encoded with the operation code is decoded by a decode unit, such as the decode unit 312. The commit pointer 720 and the latest pointer 730 are advanced or incremented in the same direction and may wrap around when reaching the end of the save_op register group 700, as shown by the arrow 750. The circular buffer of the save_op register group 700 is full when the latest pointer 730 lags the commit pointer 720 by one register in a direction of pointer advancements. The commit pointer 720 and the latest pointer 730 may be implemented by employing software, hardware logics, or combinations thereof.

In some embodiments, the CPU may divide an execution stage into multiple sub-stages. As such, during the execution of an instruction pair first instruction word, the CPU may decode multiple subsequent instruction pair first instruction words. Thus, multiple operation codes may be written into the save_op register group 700. Therefore, the CPU employs the latest pointer 730 to track a most recently uncommitted operation code. When the CPU decodes a second instruction word, such as the second instruction words 520, 612, 622, and 632, of an instruction pair, the CPU retrieves the operation code from a register 710 that is referenced by the latest pointer 730 to combine with the second instruction word.

In some embodiments, the CPU may cancel a fetched instruction word or a decoded instruction word prior to executing the fetched or decoded instruction word, for example, due to incorrect speculative execution or CPU exception. The employment of the commit pointer 720 and the latest pointer 730 enables the CPU to identify and cancel the uncommitted operation codes, shown as 740. When the execution returns after the incorrect speculative execution or the CPU exception, the uncommitted operation codes are invalidated and the committed operation code remains. For example, the CPU may invalidate the uncommitted operation codes by moving the latest pointer 730 to reference the same register 710 as the commit pointer 720.

In some embodiments, the CPU may perform context switching, for example, due to a system interrupt. In order to preserve the execution context, the CPU may save some system registers to other memory, such as general-purpose registers, a hardware stack, or a software stack, prior to the context switch and restore the CPU save registers from the other memory after returning execution from the context switch. The employment of the commit pointer 720 enables the CPU to identify a committed operation code in the save_op register group 700 for save and restore. For example, the CPU may employ system register move instructions, such as ARM's register transfer instructions, named MSR and MRS, to move the committed operation code from the save_op register group 700 to a general-purpose register prior to a context switch and move the committed operation code from the general-purpose register to the save_op register group 700 when returning execution from the context switch.

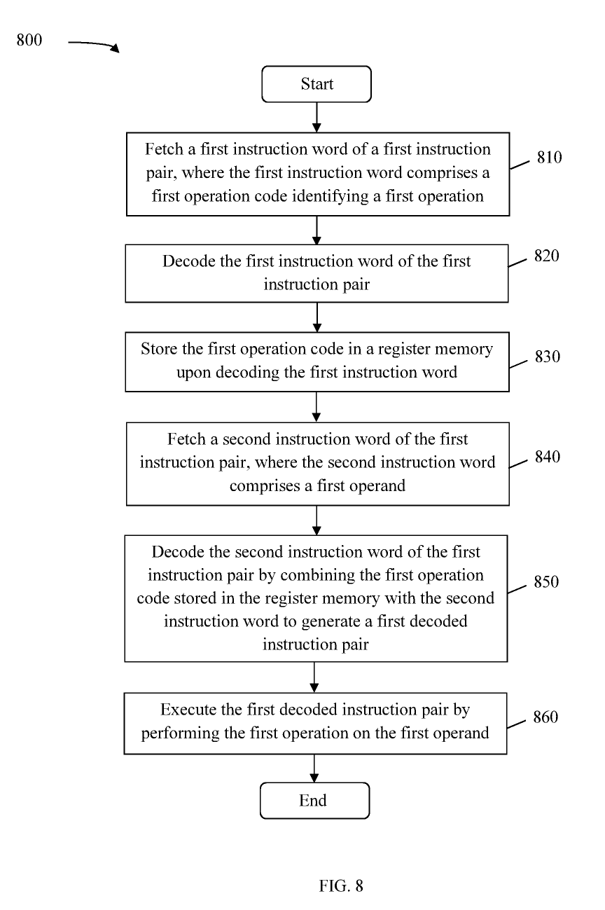

FIG. 8 is a flowchart of a method 800 for processing an instruction pair, such as the instruction pairs 500, 610, 620, and 630. The method 800 is implemented by a CPU, such as the CPU 300, when the CPU executes a program code comprising an instruction pair. At step 810, a first instruction word of a first instruction pair is fetched by a fetch unit, such as the fetch unit 311. The first instruction word comprises a first operation code identifying a first operation. The first operation may be a complex operation, such as a complex-multiply, a complex-multiple-add, and a complex-multiply-subtract. The first instruction word is encoded in a binary format similar to the first instruction word 510. At step 820, the first instruction word of the first instruction pair is decoded by a decode unit, such as the decode unit 312. The first instruction word comprises an instruction pair indicator similar to the first instruction pair indicator 511. For example, the first instruction word is decoded by determining that the first instruction pair indicator indicates that the first instruction word is a first instruction of an instruction pair encoded with an instruction pair operation code. At step 830, the first operation code is stored in a register memory upon decoding the first instruction word. The register memory is similar to the save_op register group 700. At step 840, a second instruction word of the first instruction pair is fetched by the fetch unit, where the second instruction word comprises a first operand. At step 850, the second instruction word of the first instruction pair is decoded by combining the first operation code stored in the register memory with the second instruction word to generate a first decoded instruction pair. At step 860, the first decoded instruction pair is executed by performing the first operation on the first operand.

In an embodiment of pipeline processing, the first instruction word is fetched in a first fetch stage and decoded in a first decode stage, and the second instruction word is fetched in a second fetch stage and decoded in a second decode stage, where the first decode stage and the second fetch stage are concurrent stages similar to the pipeline processing shown in the schedules 200 and 400. In addition, the first operation code is stored in the register memory in the first decode stage prior to an execution stage of the first instruction word so that the decode unit may combine the second instruction word with the first operation code in the second decode stage. Since the first operation code is stored in the register memory, a subsequent instruction pair with the same first operation code may be specified by providing the operands in a single instruction word, which may be encoded in a format as shown in the second instruction word 520. As an example, a program segment for performing 20 complex-multiplies may comprise a single instruction word encoded with a complex-multiply operation, followed by 20 instruction words, each indicating two source registers that store multiplicands for the complex-multiply operation and a destination register for storing a product of the complex-multiply operation. Thus, the instruction fetch efficiency is about the same as employing single instruction word encoded with operation code and operands.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A method implemented by a central processing unit (CPU), comprising:
decoding a first instruction word of a first instruction pair, wherein the first instruction word comprises a first operation code identifying a first operation;
storing the first operation code in a register memory upon decoding the first instruction word;
decoding a second instruction word of the first instruction pair, wherein the second instruction word comprises a first operand;
generating a first decoded instruction pair by combining the first operation code stored in the register memory with the first operand in the second instruction word; and
executing the first decoded instruction pair by performing the first operation on the first operand.

2. The method of claim 1, wherein the first instruction word further comprises a first instruction pair indicator, wherein decoding the first instruction word comprises determining that the first instruction pair indicator indicates that the first instruction word is encoded with an instruction pair operation, wherein the second instruction word further comprises a second instruction pair indicator, and wherein decoding the second instruction word comprises determining that the second instruction pair indicator indicates that the second instruction word is encoded with an instruction pair operand.

3. The method of claim 1, further comprising:
decoding a third instruction word of a second instruction pair associated with the first operation, wherein the third instruction word comprises a second operand;
generating a second decoded instruction pair by combining the first operation code stored in the register memory with the second operand in the third instruction word; and
executing the second decoded instruction pair by performing the first operation on the second operand.

4. The method of claim 1, comprising concurrently fetching the second instruction word from an instruction memory while decoding the first instruction word and storing the first operation code in the register memory.

5. The method of claim 1, wherein the register memory comprises a buffer queue comprising a first register and a second register, wherein the first operation code is stored in the first register, and wherein the method further comprises:
referencing the first register by a latest pointer upon storing the first operation code in the register memory in order to track a most recently uncommitted instruction pair operation code;
committing the first operation code for execution; and
referencing the first register by a commit pointer upon committing the first operation code in order to track a currently committed instruction pair operation code.

6. The method of claim 5, wherein the first register is a system register for CPU system-specific usage, and wherein the method further comprises:
performing a context switch while the first operation code is committed for execution;
moving the committed first operation code from the first register to a general-purpose register for general-purpose usage prior to the context switch; and
moving the first operation code from the general-purpose register to the first register after the context switch.

7. The method of claim 5, further comprising:
decoding a third instruction word of a second instruction pair subsequent to decoding the first instruction word, wherein the third instruction word comprises a second operation code identifying a second operation;
storing the second operation code in the second register upon decoding the third instruction word; and
updating the latest pointer to reference the second register upon storing the second operation code in the second register.

8. The method of claim 7, further comprising:
detecting an execution path change prior to committing the second operation code for execution; and
invalidating the second operation code in the second register.

9. The method of claim 7, wherein the buffer queue is a circular queue, wherein the first register is located at an end of the buffer queue, and wherein the second register is located at a beginning of the buffer queue.

10. The method of claim 1, wherein the first instruction word does not comprise any operand associated with the first instruction pair, and wherein the second instruction word does not comprise any operation code associated with the first instruction pair.

11. A central processing unit (CPU) comprising:
a register memory;
a control unit coupled to the register memory and configured to:
decode a first instruction word of a first instruction pair, wherein the first instruction word comprises a first operation code identifying a first operation;
store the first operation code in the register memory;
decode a second instruction word of the first instruction pair, wherein the second instruction word comprises a first operand; and
generate a first decoded instruction pair by combining the first operation code stored in the register memory with the first operand in the second instruction word; and
an execution unit coupled to the control unit and configured to execute the first decoded instruction pair by performing the first operation on the first operand.

12. The CPU of claim 11, wherein the control unit is further configured to:
decode a third instruction word of a second instruction pair associated with the same first operation, wherein the third instruction word comprises a second operand; and
generate a second decoded instruction pair by combining the first operation code stored in the register memory with the second operand in the third instruction word, and
wherein the execution unit is further configured to execute the second decoded instruction pair by performing the first operation on the second operand.

13. The CPU of claim 11, wherein the register memory comprises a commit pointer, a latest pointer, and a circular buffer queue comprising a first register and a second register, wherein the first operation code is stored in the first register, and wherein the control unit is further configured to:
reference the first register by the latest pointer upon storing the first operation code in the register memory in order to track a most recently uncommitted instruction pair operation code;
commit the first operation code for execution; and
reference the first register by the commit pointer upon committing the first operation code in order to track a currently committed instruction pair operation code.

14. The CPU of claim 13, wherein the first register is a system register for CPU system-specific usage, wherein the register memory further comprises a general-purpose register for general-purpose usage, and wherein the execution unit is further configured to:
perform a context switch while the first operation code is committed for execution;
move the first operation code from the first register to the general-purpose register prior to the context switch; and
move the first operation code from the general-purpose register to the first register after the context switch.

15. The CPU of claim 13, wherein the control unit is further configured to:
decode a third instruction word of a second instruction pair subsequent to decoding the first instruction word, wherein the third instruction word comprises a second operation code identifying a second operation;
store the second operation code in the second register upon decoding the third instruction word; and
update the latest pointer to reference the second register upon storing the second operation code in the second register.

16. The CPU of claim 15, wherein the control unit is further configured to remove the second operation code from an execution path prior to committing the second operation code for execution.

17. The CPU of claim 11, further comprising a memory interface configured to couple the control unit to an instruction memory, wherein the control unit is further configured to concurrently fetch the second instruction word from the instruction memory via the memory interface while the first instruction word is decoded and the first operation code is stored in the register memory.

18. The CPU of claim 11, wherein the register memory comprises a general-purpose register, wherein the first operand indicates a register identifier (ID) identifying the general-purpose register, and wherein the first operand is a source operand or a destination operand.

19. The CPU of claim 11, wherein the first instruction word and the second instruction word are binary-encoded, fixed-length instruction words comprising 8 bits, 16 bits, or 32 bits.

20. The CPU of claim 11, wherein the CPU is a pipelined CPU.
